(19) United States
(12) Patent Application Publication
(10) Pub. No.: US 2025/0044666 A1
(43) Pub. Date: Feb. 6, 2025

(54) Camera Modules with Mechanical Iris Assemblies

(71) Applicant: Apple Inc., Cupertino, CA (US)

(72) Inventors: Bin Xu, Sunnyvale, CA (US); Zhuzhen Ji, Milpitas, CA (US); Aurelien R. Hubert, San Jose, CA (US)

(21) Appl. No.: 18/666,515

(22) Filed: May 16, 2024

Related U.S. Application Data
(60) Provisional application No. 63/529,944, filed on Jul. 31, 2023.

(51) Int. Cl. G03B 9/06

(52) U.S. Cl. CPC G03B 9/06

(57) ABSTRACT

Various embodiments disclosed herein include mechanical iris assemblies, as well as camera modules and devices that incorporate these mechanical iris assemblies. The mechanical iris assemblies described herein include a housing, a rotor plate, a set of blade elements, and an actuator arrangement. The actuator assembly may include a voice coil actuator. In some variations, a voice coil actuator includes a magnet, a first coil, and a second coil, and a controller is configured to concurrently drive current through the first coil and the second coil in opposite directions. In other variations, a voice coil actuator includes at least one magnet and a set of arcuate-shaped coils. In still other variations, a voice coil actuator includes at least one magnet and a printed circuit that defines a coil that includes an inner trace, an outer trace, and a set of connecting traces that connect the inner trace to the outer trace.

### CROSS-REFERENCE TO RELATED APPLICATION

This application is a nonprovisional and claims the benefit under 35 U.S.C. § 119 (e) of U.S. Provisional Patent Application No. 63/529,944, filed Jul. 31, 2023, the contents of which are incorporated herein by reference as if fully disclosed herein.

### FIELD

This disclosure relates to camera modules that include mechanical iris assemblies, and more specifically mechanical iris assemblies that include voice coil actuators.

### BACKGROUND

Cameras continue to be an important feature of consumer electronics devices such as smartphones, tablets, and computers. While larger cameras, such as single-lens reflex cameras (“SLR cameras”), typically utilize a mechanical iris to controllably adjust the aperture stop of the camera, many cameras in consumer electronics devices do not have adjustable apertures. Space is at a premium in consumer electronics devices, and it may be difficult to incorporate mechanical iris assemblies within the size and space constraints of such a device. Accordingly, it may be desirable to provide camera modules with compact mechanical iris assemblies.

### SUMMARY

The present disclosure relates to mechanical iris assemblies, as well as cameras and devices incorporating these mechanical iris assemblies. In some embodiments, a camera has an optical assembly with an optical axis, where the optical assembly includes a lens module, a mechanical iris assembly, and a controller. The mechanical iris assembly includes a housing, a set of blade elements, a rotor plate, an actuator assembly. The actuator assembly includes a magnet that is fixed relative to the rotor plate, a first coil, and a second coil, such that the first coil and the second coil are positioned in a magnetic field of the magnet. The controller is configured to concurrently drive current through the first coil and the second coil in opposite directions to rotate the rotor plate relative to the housing. Additionally, the mechanical iris assembly is configured such that rotation of the rotor plate relative to the housing rotates the set of blade elements relative to the housing.

In some of these instances, the mechanical iris assembly comprises a set of ball bearings and a preloading plate formed from a ferritic material. Additionally or alternatively, the housing includes a front housing element and a rear housing element, such that the rear housing element comprises a sidewall that defines a cavity and the lens barrel extends at least partially into the cavity. In some of these variation, the rotor plate circumferentially surrounds the sidewall. Additionally or alternatively, the magnet has a magnetization direction that is parallel to the optical axis.

Other embodiments are directed to a camera includes an optical assembly that has an optical axis and includes a lens module and a mechanical iris assembly. The mechanical iris assembly includes a housing, a set of blade elements a rotor plate, and an actuator assembly, wherein the actuator assembly is configured to rotate the rotor plate relative to the housing, and the mechanical iris assembly is configured such that rotation of the rotor plate relative to the housing rotates the set of blade elements relative to the housing. The actuator assembly includes at least one magnet and a set of coils, each of which has an arcuate shape.

In some of these variations, each coil of the set of coils has a shape that includes a curved inner side and a curved outer side that curve in a common direction. In some of these instances, the curved inner side and the curved outer side of each coil of the set of coils are parallel. For example, the shape of each coil of the set of coils may form an annular segment. In some of these variations, the set of coils are arranged around the optical axis and may collectively subtend an angle. In some variations, the set of coils collectively subtend an angle of least 180 degrees.

Additionally or alternatively, the at least one magnet includes a magnet having an annular shape. In some of these instance, the magnet includes a first plurality of magnetic regions, each having a corresponding magnetization direction that is perpendicular to the optical axis. The magnet may further include a second plurality of magnetic regions, each having a corresponding magnetization direction that is parallel to the optical axis. The first plurality of magnetic regions may alternate with the second plurality of magnetic regions.

Still other embodiments are directed to a mechanical iris assembly that includes a housing, a set of blade elements, a rotor plate, a printed circuit defining at least one coil, and an actuator assembly. The actuator assembly includes at least one magnet and the at least one coil. The actuator assembly is configured to rotate the rotor plate relative to the housing, and the mechanical iris assembly is configured such that rotation of the rotor plate relative to the housing rotates the set of blade elements relative to the housing. In some of these variations, the at least one coil includes a first coil, such that the first coil includes an inner trace, an outer trace, and a set of connecting traces that electrically connect the inner trace to the outer trace in parallel. In some variations, the mechanical iris assembly includes a set of ball bearings, wherein the set of ball bearings are positioned to extend through one or more openings defined through the printed circuit.

Additionally or alternatively, the at least one coil may include a second coil that has an inner trace, an outer trace, and a set of connecting traces that electrically connect the inner trace of the second coil to the outer trace of the second coil in parallel. The mechanical iris assembly may include a controller configured to selectively drive current through the first coil and the second coil. In some instances, the controller is configured, during a period of time, to concurrently drive current through the first and second coils such that i) current flows through the set of connecting traces of the first coil in a first radial direction, and ii) current flows through the set of connecting traces of the second coil in a second radial direction opposite the first radial direction.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A illustrates a device as described herein having a camera with a mechanical iris assembly. FIG. 1B depicts exemplary components of the device of FIG. 1A. FIG. 1C illustrates components of the camera with the mechanical iris assembly of FIG. 1A.

FIG. 2A shows a perspective view of an optical assembly with a mechanical iris assembly as described herein. FIGS. 2B and 2C show an exploded perspective view and a cross-sectional side view, respectively, of the optical assembly of FIG. 2A.

FIGS. 3A and 3B show side and top views, respectively, of a variation of a voice coil actuator that may be used with the mechanical iris assemblies described herein.

FIGS. 4A and 4B show top and exploded perspective views, respectively, of a variation of a voice coil actuator that includes a set of coils having arcuate shapes.

FIGS. 5A and 5B show top and exploded perspective views, respectively, of another variation of a voice coil actuator that includes a set of coils having arcuate shapes.

FIGS. 6A and 6B show top and exploded perspective views, respectively, of a variation of a voice coil actuator that includes a set of coils formed as part of a printed circuit.

FIG. 7A shows a perspective view of an optical assembly with a variation of a mechanical iris assembly as described herein. FIGS. 7B and 7C show an exploded perspective view and a cross-sectional side view, respectively, of the optical assembly of FIG. 7A.

It should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

Directional terminology, such as “top,” “bottom”, “upper”, “lower”, “front”, “back”, “over”, “under”, “above”, “below”, “left”, “right”, “vertical”, “horizontal”, etc. is used with reference to the orientation of some of the components in some of the figures described below, and is not intended to be limiting. Because components in various embodiments can be positioned in a number of different orientations, directional terminology is used for purposes of illustration to demonstrate the relative orientation between components of the systems and devices described herein. The directional terminology is intended to be construed broadly, and therefore should not be interpreted to preclude components being oriented in different ways. Also, as used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Various embodiments disclosed herein include mechanical iris assemblies, as well as camera modules and devices that incorporate these mechanical iris assemblies. The mechanical iris assemblies described herein include a housing, a rotor plate, a set of blade elements, and an actuator arrangement. The actuator arrangement is configured to rotate the rotor plate relative to the housing, and the mechanical iris assembly is configured such that rotation of the rotor plate also rotates the set of blade elements relative to the housing. Accordingly, the mechanical iris assembly may controllably move the set of blade elements to adjust the size and/or shape of an input aperture of a camera module.

In some variations, a mechanical iris assembly has an actuator assembly that includes at least one voice coil actuator. In some variations, a voice coil actuator includes a magnet, a first coil, and a second coil. The first coil and the second coil may be positioned in a magnetic field of the magnet, and a controller may be configured to concurrently drive current through the first coil and the second coil in opposite directions. In other variations, a voice coil actuator includes at least one magnet and a set of arcuate-shaped coils. The set of arcuate-shaped coils may each have a shape that forms an annular segment, and multiple coils may be arranged around a common point such an optical axis of the mechanical iris assembly. In still other variations, a voice coil actuator includes at least one magnet and a printed circuit that defines one or more coils. For example, the printed circuit may define a coil that includes an inner trace, an outer trace, and a set of connecting traces that connect the inner trace to the outer trace.

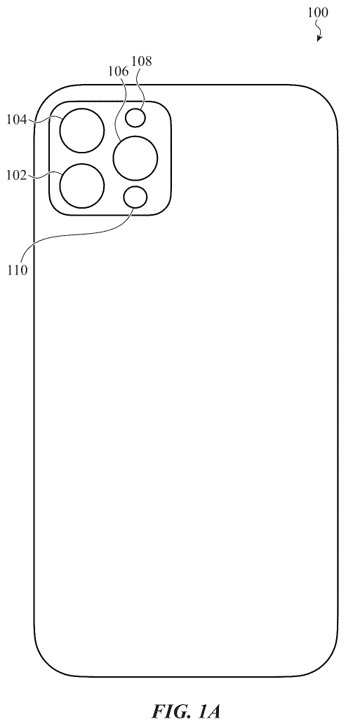

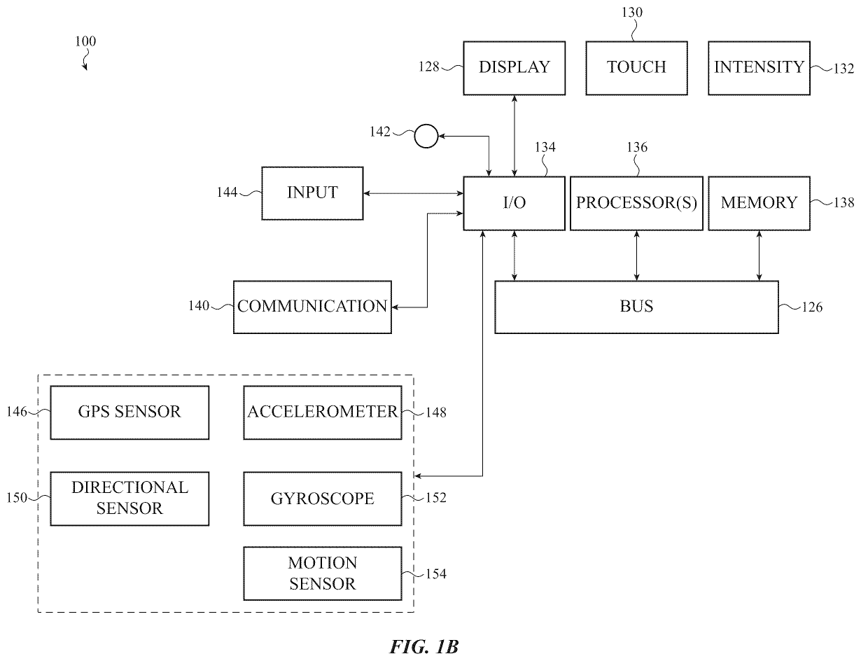

These and other embodiments are discussed below with reference to FIGS. 1A-7C. However, those skilled in the art will readily appreciate that the detailed description given herein with respect to these Figures is for explanatory purposes only and should not be construed as limiting.

The mechanical iris assemblies described herein may be incorporated into a camera module, which in turn may be incorporated into an electronic device such as a phone, tablet, computer, or the like. FIG. 1A depicts an example device 100 as described herein. As shown there, the device 100 includes a first camera 102 having a mechanical iris assembly. The mechanical iris assembly allows for controllably adjusting the size of an input aperture of the first camera 102, thereby providing the first camera 102 with multiple aperture stops.

In some instances, the first camera 102 is part of a multi-camera system. For example, in the variation shown in FIG. 1A, the first camera 102 is part of a multi-camera system having a second camera 104, and a third camera 106. The second camera 104 and/or third camera 106 may also include mechanical iris assemblies as described herein, but need not. It should be appreciated that the device 100 may include a single camera, or a multi-camera system having any number of cameras (with any relative positioning) as may be desired. Additionally, while shown as placed on the rear of a device 100, it should be appreciated that a camera having a mechanical iris assembly may be additionally or alternatively placed on the front (e.g., a front side having a display) or any other side of the device as desired.

In some instances, the device 100 may include a flash module 108. The flash module 108 may provide illumination to some or all of the fields of view of the cameras of the device (e.g., the fields of view of the first camera 102, the second camera 104, and/or the third camera 106). This may assist with image capture operations in low light settings. Additionally or alternatively, the device 100 may further include a depth sensor 110 that may calculate depth information for a portion of the environment around the device 100. Specifically, the depth sensor 110 may calculate depth information within a field of coverage (i.e., the widest lateral extent to which the depth sensor is capable of providing depth information). The field of coverage of the depth sensor 110 may at least partially overlap the field of view of one or more of the cameras (e.g., the fields of view of the first camera 102, second camera 104, and/or third camera 106). The depth sensor 110 may be any suitable system that is capable of calculating the distance between the depth sensor 110 and various points in the environment around the device 100.

The depth information may be calculated in any suitable manner. In one non-limiting example, a depth sensor may utilize stereo imaging, in which two images are taken from different positions, and the distance (disparity) between corresponding pixels in the two images may be used to calculate depth information. In another example, a depth sensor may utilize structured light imaging, whereby the depth sensor may image a scene while projecting a known pattern (typically using infrared illumination) toward the scene, and then may look at how the pattern is distorted by the scene to calculate depth information. In still another example, a depth sensor may utilize time of flight sensing, which calculates depth based on the amount of time it takes for light (typically infrared) emitted from the depth sensor to return from the scene. A time-of-flight depth sensor may utilize direct time of flight or indirect time of flight, and may illuminate an entire field of coverage at one time, or may only illuminate a subset of the field of coverage at a given time (e.g., via one or more spots, stripes, or other patterns that may either be fixed or may be scanned across the field of coverage). In instances where a depth sensor utilizes infrared illumination, this infrared illumination may be utilized in a range of ambient conditions without being perceived by a user.

In some embodiments, the device 100 is a portable multifunction electronic device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer, which may have a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content by transmitting, via a wired or wireless connection, data (e.g., image data or video data) to an integrated or external display generation component to visually produce the content.

FIG. 1B depicts exemplary components of the device 100. In some embodiments, device 100 has a bus 126 that operatively couples an I/O section 134 with one or more computer processors 136 and memory 138. The I/O section 134 can be connected to display 128, which can have touch-sensitive component 130 and, optionally, intensity sensor 132 (e.g., contact intensity sensor). In addition, I/O section 134 can be connected with communication unit 140 for receiving application and operating system data, using Wi-Fi, Bluetooth, near field communication (NFC), cellular, and/or other wireless communication techniques. The device 100 can include input mechanisms 142 and/or 144. Input mechanism 142 is, optionally, a rotatable input device or a depressible and rotatable input device, for example. Input mechanism 142 is, optionally, a button, in some examples. The device 100 optionally includes various sensors, such as GPS sensor 146, accelerometer 148, directional sensor 150 (e.g., compass), gyroscope 152, motion sensor 154, and/or a combination thereof, all of which can be operatively connected to I/O section 134. Some of these sensors, such as accelerometer 148 and gyroscope 152 may assist in determining an orientation of the device 100 or a portion thereof.

Memory 138 of the device 100 can include one or more non-transitory computer-readable storage mediums, for storing computer-executable instructions, which, when executed by one or more computer processors 136, for example, can cause the computer processors to perform the techniques that are described here (such as actuating the mechanical iris assemblies described herein). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

The processor 136 can include, for example, dedicated hardware as defined herein, a computing device as defined herein, a processor, a microprocessor, a programmable logic array (PLA), a programmable array logic (PAL), a generic array logic (GAL), a complex programmable logic device (CPLD), an application-specific integrated circuit (ASIC), a field-programmable gate array (FPGA), or any other programmable logic device (PLD) configurable to execute an operating system and applications of device 100, as well as to facilitate capturing of images as described herein. Device 100 is not limited to the components and configuration of FIG. 1B, but can include other or additional components in multiple configurations.

FIG. 1C illustrates components of the first camera 102 of the device 100 of FIG. 1A. The first camera 102 includes a lens module 112, an image sensor 114, a mechanical iris assembly 116, and a controller 118. The lens module 112, the image sensor 114, and the mechanical iris assembly 116 collectively form an optical assembly of the camera, which collects and measures light 122 entering the camera 102 to capture images.

Specifically, the mechanical iris assembly 116 is positioned to receive light 122 entering the camera 102 from the environment (e.g., emitted and/or reflected from the scene surrounding the camera 102), The mechanical iris assembly 116 defines an input aperture through which light may pass through the mechanical iris assembly 116, and includes a set of blade elements 119 that are moveable to change the size of the input aperture. Each blade element 119 is formed from or coated with an opaque material that blocks light at one or more wavelengths measured by the camera 102, such that portions of the blade element 119 are capable of blocking light form entering the camera 102.

Movement of the blade elements 119 may change the size of the input aperture between a minimum size and a maximum size. In some instances the mechanical iris assembly 116 is capable of being placed in a closed configuration in which blade elements 119 block any light 122 from passing through the mechanical iris assembly 116 (e.g., the input aperture is “closed” and thus has zero area). In other instances, the minimum size of the input aperture may be a non-zero size, such that the input aperture is “open” and the set of blade elements 119 allow at least some light to pass through the mechanical iris assembly 116. In these instances, the input aperture may remain open during operation of the camera 102, and the mechanical iris assembly 116 may be configured to always pass light 122 through the input aperture. Overall, the size of the input aperture may be selectively changed to control how much light passes through the mechanical iris assembly 116 to other components of the optical assembly (e.g., the lens module 112 and the image sensor 114). It should be appreciated that, in some variations, the mechanical iris assembly 116 is configured such that movement of the blade elements 119 may additionally or alternatively change the shape of the input aperture.

Accordingly, the mechanical iris assembly 116 further includes an actuator arrangement 120 that is configured to control the relative positioning of the set of blade elements 119. The different variations of actuator arrangements 120 described herein include one or more voice coil actuators, each of which includes a corresponding set of magnets and set of coils. Each voice coil actuator is configured to generate a Lorentz force between two components as current is driven through the set of coils, such as described in more detail herein. The actuator arrangement 120 may be controlled by the controller 118 to set the relative positioning of the set of blade elements 119, and thereby control the size and/or shape of the input aperture. Specifically, the controller 118 may include a driver that is configured to operate the actuator arrangement. For example, in instances where the actuator arrangement 120 includes a voice coil actuator, the controller 118 may include a voice coil driver that is configured to drive current through one or more coils of the voice coil actuator. During operation of the camera 102, the controller 118 may receive (e.g., from other components within the camera 102 or the electronic device 100) or otherwise determine (e.g., using a processor as described herein) a target relative positioning of the set of blade element 119, and may control the actuator arrangement 120 to move the set of blade elements 119 to achieve the target relative positioning.

In some variations, the mechanical iris assembly 116 may include one or more position sensors 121 (e.g., a Hall effect sensor or the like) that are configured to determine the relative position of one or more components of the mechanical iris assembly 116. Information from the position sensor(s) 121 may help in controlling the positioning of the set of blade elements 119. For example, the controller 118 may receive information from the one or more position sensors 121, and may utilize this information as feedback in controlling the actuator arrangement 120.

The lens module 112 is positioned to receive light 122 that passes through the input aperture of the mechanical iris assembly 116, and to direct the light 122 along an optical axis 124 of the optical assembly to the image sensor 114. As used herein, the optical axis of an optical assembly is considered to extend through the input aperture of the mechanical iris assembly, through the lens assembly, and to the image sensor. The portion of the optical axis that extends through the mechanical iris assembly will also be referred to herein as the “optical axis of the mechanical iris assembly.” Similarly, the portion of the optical axis that extends through the lens assembly will also be referred to herein as the “optical axis of the lens assembly.” The image sensor 114 may be operated to capture images using light received along the optical axis 124. The lens module 112 includes one or more lens groups (e.g., a single lens group or multiple lens groups), each of which includes one or more lens elements (e.g., made from glass, plastic, or the like) that are configured to receive and refract light along the optical axis 124.

In some variations, the camera 102 may include one or more additional actuators (e.g., a bearing actuator, a stepped motor, a voice coil motor actuator, a piezoelectric actuator, a leaf spring actuator, combinations thereof, and the like) that are configured to move other components of the optical assembly within the camera 102. For example, one or more of these additional actuators may move the image sensor 114 in one or more directions relative to the lens module 112. Additionally or alternatively, one or more of these additional actuators may move the lens module 112 (and, in some of these variation, the mechanical iris assembly 116) in one or more directions relative to the image sensor 114. Depending on the direction of movement, relative movement between the lens module 112 and the image sensor 114 may provide autofocus and/or optical image stabilization capabilities to the camera 102. When the lens module 112 includes multiple lens groups, some of the lens groups may be moveable relative to other lens groups using one of these additional actuators. This may allow for selective adjustment of the focal length of the lens module 112.

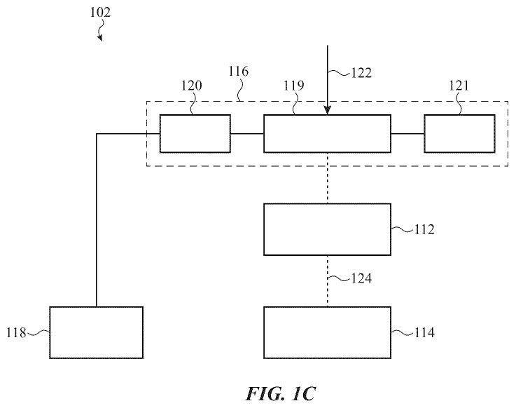

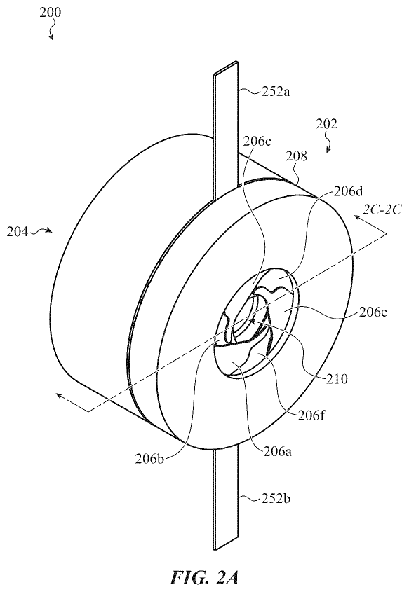

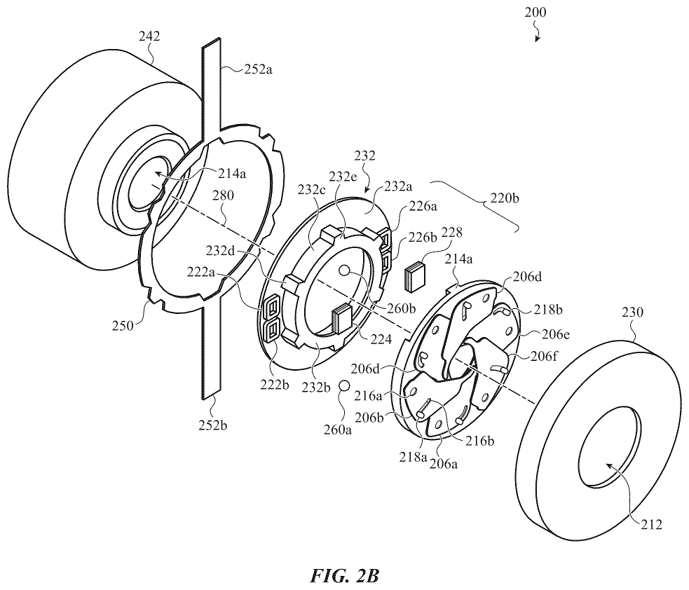

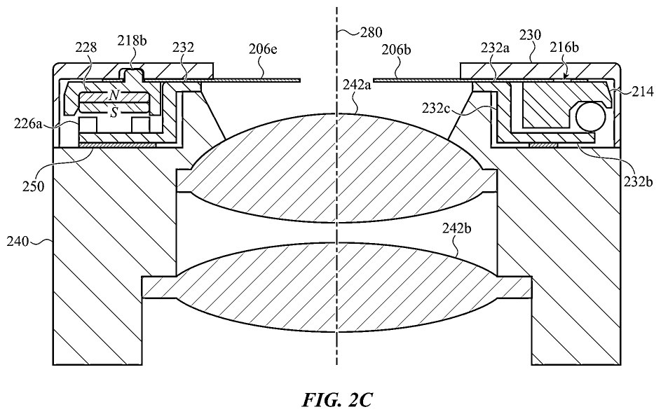

FIGS. 2A-2C show perspective, exploded, and cross-sectional side views (taken along line 2C-2C), respectively, of a variation of an optical assembly 200 that includes a variation of a mechanical iris assembly 202 as described herein. The mechanical iris assembly 202 may be positioned at least partially in front of a lens module 204 along an optical axis 280 of the optical assembly 200, such that mechanical iris assembly 202 controls the amount of light received by the lens module 204. The mechanical iris assembly 202 includes a set of blade elements 206a-206f and a housing 208. The set of blade elements 206a-206f and the housing 208 collectively define an input aperture 210 of the mechanical iris assembly 202, and the set of blade elements 206a-206f are moveable relative to the housing 208 to adjust the size of the input aperture 210.

Specifically, the housing 208 defines an opening 212 through which light may enter the mechanical iris assembly 202. Depending on the relative positioning of the set of blade elements 206a-206f, the set of blade elements 206a-206f may at least partially block the opening 212 to further limit the light that enters the mechanical iris assembly 202 through the opening 212. The unblocked portion of the opening 212 forms the input aperture 210, which may vary in size and/or shape with movement of the set of blade elements 206a-206f. In some embodiments, the set of blade elements 206a-206f may be positioned such that they do not block any portion of the opening 212, in which case the boundary of the opening 212 defines the size and shape of the input aperture 210 (e.g., the input aperture 210 has the same size and shape as the opening 212 defined in the housing 208). Otherwise, the set of blade elements 206a-206f at least partially defines the size and shape of the input aperture 210 by blocking at least a portion of the opening 212.

To move the set of blade elements 206a-206f relative to the housing 208, the mechanical iris assembly 202 further includes a rotor plate 214 that is configured to rotate relative to the housing 208. Specifically, the mechanical iris assembly 202 is configured such that rotation of the rotor plate 214 relative to the housing 208 also rotates each of the set of blade elements 206a-206f relative to the housing 208. In some instances, the mechanical iris assembly 202 may utilize a series of posts and channels that cooperate to move the blade elements 206a-206f as the rotor plate 214 rotates relative to the housing 208. Specifically, a first component (e.g., the rotor plate 214) may define a post that extends at least partially into a channel defined by a second component (e.g., a blade element of the set of blade elements 206a-206f) in a manner that limits relative movement between the two components.

For example, each blade element of the set of blade elements 206a-206f may form a first post-channel pair with the housing 208 (or another component with a fixed position relative to the housing 208, which for the purpose of this discussion, is considered to be part of housing 208) and a second post-channel arrangement with the rotor plate 214 (or another component with a fixed position relative to the rotor plate 214, which for the purpose of this discussion, is considered to be part of the rotor plate 214). One of these post-channel pairs creates a pivot point between the blade element and one of the rotor plate 214 or the housing 208, while the other post-channel arrangement drives rotation of the blade around the pivot point as the rotor plate 214 rotates relative to the housing 208.

For example, in the variation shown in FIGS. 2A-2C, each blade of the set of blade elements 206a-206f defines a first channel 216a and a second channel 216b extending at least partially through the blade (the first channel 216a and second channel 216b are only labeled for blade 206b, but it should be appreciated that every blade of the set of blade elements 206a-206b may include corresponding first and second channels). The housing 208 defines a first set of posts (not shown), each of which extends at least partially into the first channel 216a of a corresponding blade of the set of blade elements 206a-206f. Accordingly, the first channel 216a of a given blade element and the corresponding post of the first set of posts forms a first post-channel arrangement (e.g., between the blade element and the housing 208).

Similarly, the rotor plate 214 defines a second set of posts (e.g., including a first post 218a shown in FIG. 2B and a second post 218b shown in FIGS. 2B and 2C), each of which extends at least partially into the second channel 216b of a corresponding blade element of the set of blade elements 206a-206f. For example, the first post 218a extends through the second channel 216b of blade element 206b in FIG. 2B. Accordingly, the second channel 216b of a given blade element and the corresponding post of the second set of posts forms a second post-channel arrangement (e.g., between the blade element and the rotor plate 214). In the variation shown in FIG. 2B, the first post-channel arrangement for each blade element defines a pivot point of the blade element, while the second post-channel arrangement drives rotation of the blade element as the rotor plate 214 rotates relative to the housing 208. It should be appreciated that this is just one example, and in other instances the function of these post-channel arrangements may be switched. Similarly, a given blade element may instead include one or more posts in place of the first and/or second channels 216a, 216b, and the post or posts may extend at least partially into a corresponding channel or channels defined in the housing 208 and/or rotor plate 214.

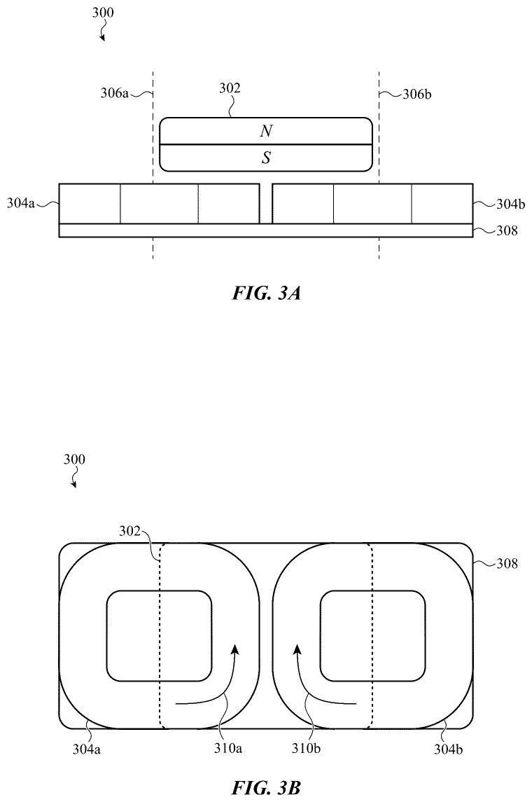

To drive rotation of the rotor plate 214 relative to the housing 208, the mechanical iris assembly 202 includes an actuator arrangement that includes at least one voice coil actuator, each of which includes at least one coil and at least one magnet. In the embodiment shown in FIGS. 2A-2C, the actuator arrangement includes a first voice coil actuator 220a and a second voice coil actuator 220b. The first voice coil actuator 220a includes at least one coil (e.g., a pair of coils including a first coil 222a and a second coil 222b) and at least one magnet (e.g., a magnet 224). The coils of the first voice coil actuator 220a are fixed relative to the housing 208 (e.g., attached to the housing 208 or another component that is fixed relative to the housing 208) and are positioned within a magnetic field generated by the at least one magnet (e.g., magnet 224) of the first voice coil actuator 220a. The magnet(s) of the first voice coil actuator 220a are fixed relative to the rotor plate 214. When current is run through one or more coils of the voice coil actuator 220a (e.g., using a controller such as the controller 118 described in relation to FIG. 1C), a corresponding Lorentz force will be generated in a direction perpendicular to an optical axis 280. Similarly, the second voice coil actuator 220b includes at least one coil (e.g., a pair of coils including a first coil 226a and a second coil 226b) and at least one magnet (e.g., a magnet 228), and may also be configured to generate a corresponding Lorentz force in a direction perpendicular to the optical axis 280 of the optical assembly 200. Collectively, these Lorentz forces may rotate the rotor plate 214 relative to the housing 208 to actuate the mechanical iris assembly 202. Examples of suitable actuator arrangements are described in more detail herein with respect to FIGS. 3A-6B.

To power the various coils of the actuator arrangement, the mechanical iris assembly 202 may include a flex circuit 250 configured to route power and/or control signals to the mechanical iris assembly 202 (e.g., from a controller as described herein). The flex circuit 250 may be connected to the housing 208 in any suitable manner that allows the flex circuit 250 to be electrically connected to the coils of the actuator arrangement (e.g., via direct connection between the flex circuit 250 and the coils or via one or more intermediate components such as conductive traces deposited on one or more portions of the housing 208). While shown in FIGS. 2B and 2C as connected to a rear surface of the housing 208 (e.g., to a rear surface of a rear housing element 232 of the housing 208), in other variations the flex circuit 250 may be positioned at least partially inside of the housing 208. In some variations, the flex circuit 250 may include one or more tab portions (e.g., a first tab portion 252a and second tab portion 252b as shown in FIGS. 2A and 2B) that extend externally from the mechanical iris assembly. The tab portions may allow for the flex circuit 250 to be electrically connected to a controller, as well as any other portions of the camera module that incorporates the optical assembly 200 and/or an electronic device that incorporates the camera module as may be desired. This may facilitate control of the mechanical iris assembly 202 via a controller as described herein.

In some instances, the mechanical iris assemblies described herein may be configured such that a lens module extends partially through the mechanical iris assembly. For example, in the variation of the optical assembly 200 shown in FIGS. 2A-2C, the housing 208 includes a front housing element 230 and a rear housing element 232. The front and rear housing elements 230, 232 may collectively form an interior volume in which the rotor plate 214 is positioned. The opening 212 of the housing 208 may be defined in and extend through the front housing element 230, such that light enters the mechanical iris assembly 202 through the front housing element 230.

The rear housing element 232 may be shaped to receive a portion of the lens module 204. Specifically, the rear housing element 232 may include a first portion 232a, a second portion 232b elevated relative to the first portion 232a, and a sidewall 232c connecting the first portion 232a and the second portion 232b. The sidewall 232c defines a cavity that is sized to receive a portion of the lens module 204. For example, the lens module 204 may include a lens barrel 240 and a set of lens elements 242a-242b (which may include a single lens element or a plurality of lens elements depending on the design of the lens module 204). The lens barrel 240 houses and holds the set of lens elements 242a-242b, as well as any other optical elements (e.g., aperture layers, filters, or the like) of the lens module 204. The optical assembly 200 may be configured such that a portion of the lens barrel 240 extends at least partially into the cavity defined by the sidewall 232c of the rear housing element 232. In this way, at least a portion of the sidewall 232c (and thus a portion of the housing 208) may at least partially encircle a portion of the lens barrel 240.

Additionally, the rotor plate 214 may be positioned within the housing 208 such that the rotor plate 214 encircles the sidewall 232c of the rear housing element 232. In these instances, the rotor plate 214 may also at least partially encircle a portion of the lens module 204 (e.g., when the lens barrel 240 is at least partially positioned within the cavity defined by the sidewall 232c as shown in FIG. 2C). Accordingly, the rotor plate 214 may positioned such that it rotates around the lens barrel 240. Positioning components of the mechanical iris assembly 202 in this manner may reduce the overall height of the optical assembly 200, and may thereby also reduce the overall height of a camera module incorporating the optical assembly 200.

In some variation, one or more portions of the housing 208 may contact the lens module 204, which may at least partially control the relative positioning between the mechanical iris assembly 202 and the lens module 204. For example, in variations where the rear housing element 232 includes a second portion 232b that is elevated relative to a first portion 232a as described above, the optical assembly 200 may be assembled such that the second portion 232b contacts a front surface of the lens barrel 240 (e.g., via direct contact or indirect contact with an intermediate component such as a spacer positioned between the second portion 232b and the lens barrel 240). In this way, the second portion 232b of the rear housing element 232 may be positioned between the lens barrel 240 and the set of blade elements 206a-206f. This may limit how far the lens module 204 may be inserted into the mechanical iris assembly 202, and may thereby prevent the lens module 204 from contacting or otherwise interfering with movement of the set of blade elements 206a-206f.

Additionally or alternatively, one or more other portions of the housing 208 may contact the lens module 204. For example, one or more portions of the sidewall 232c of the rear housing element 232 may contact the lens barrel 240, which may help to center the input aperture 210 of the mechanical iris assembly with respect to the lens module 240 (and thereby align the optical axis of the mechanical iris assembly 202 with the optical axis of the lens module 204). In some variations, the first portion 232a of the rear housing element 232 and/or a portion of the front housing element 230 may contact corresponding portions of the lens module 204 when the optical assembly 200 is assembled. Similarly, contact between any of the portions of the housing 208 may include direct contact between the two components, or may include indirect contact between the two components via an intermediate component. For example, the first portion 232a of the rear housing element 232 may indirectly contact the lens barrel 240 via a flex circuit 250 positioned therebetween.

The mechanical iris assembly 202 may be configured to limit the stroke of the rotor plate 214, which may thereby limit the range of motion of the set of blade elements 206a-206f. In some variations, the post-channel arrangements between the set of blade elements 206a-206f and the rotor plate 214 and/or the housing 208 may limit the range of positions to which the set of blade elements 206a-206f may be actuated. This may, in turn, limit the stroke of the rotor plate 214.

Additionally or alternatively, the rotor plate 214 may be configured to physically engage with the housing 208 during rotation to limit further rotation of the rotor plate 214. For example, in the variation shown in FIGS. 2A-2C, the sidewall 232c of the rear housing element 232 may include one or more protrusions (e.g., a first protrusion 232d and a second protrusion 232e are labeled in FIG. 2B) that extend laterally from surrounding portions of the sidewall 232c relative to the optical axis 280 (e.g., perpendicular to the optical axis 280). The rotor plate 214 may include a protrusion 214a, and this protrusion 214a may be positioned to contact the first protrusion 232d of the sidewall 232c when the rotor plate 214 is rotated in a first direction (e.g., to prevent further rotation in the first direction). The rotor plate 214 may be further positioned such that the protrusion 214a contacts the second protrusion 232e of the sidewall 232c when the rotor plate 214 is rotated in a second direction opposite the first direction (e.g., to prevent further rotation in the second direction). Accordingly, the spacing between the first protrusion 232d and the second protrusion 232e may define the stroke range of the rotor plate 214. In this way, the engagement between the rotor plate 214 and the housing 208 (e.g., via rear housing element 232) may limit the stroke range of the rotor plate 214.

FIGS. 3A and 3B show side and top views, respectively, of a voice coil actuator 300 that may be used with the mechanical iris assemblies as described herein. For example, the first and second voice coil actuators 220a, 220b of the mechanical iris assembly 202 of FIGS. 2A-2C may each be configured the same as the voice coil actuator 300 shown in FIGS. 3A and 3B. Specifically, the voice coil actuator 300 includes a magnet 302 (shown in phantom in FIG. 3B) and multiple coils that include at least a first coil 304a and a second coil 304b. The magnet 302 may be attached to or otherwise incorporated into a rotor plate of a mechanical iris assembly (such as the rotor plate 214 of the mechanical iris assembly 202 of FIGS. 2A-2C), and the first and second coils 304a, 304b, may be fixed relative to a housing of the mechanical iris assembly (such as the housing 208 of the mechanical iris assembly 202 of FIGS. 2A-2C).

Each of the first coil 304a and second coil 304b may be a planar coil that is configured such that current driven through the coil flows around a corresponding winding axis. Specifically, the first coil 304a may be formed (e.g., wound) around a first winding axis 306a, and the second coil 304b may be formed (e.g., wound) around a second winding axis 306b. When a mechanical iris assembly including the voice coil actuator 300 is incorporated into an optical assembly, the first and second coils 304a, 304b may be incorporated into a mechanical iris assembly such that these winding axes are parallel to the optical axis of the mechanical iris assembly. The first coil 304a may be laterally spaced from the second coil 304b (e.g., may be positioned side-by-side in a common plane), which may increase the stroke range of the voice coil actuator 300 as compared to voice coil actuators that utilize a single coil.

Specifically, when the voice coil actuator 300 is incorporated into a mechanical iris assembly such as described herein, the first coil 304a and the second coil 304b may each be simultaneously positioned within a magnetic field of the magnet 302. In the variation shown in FIGS. 3A and 3B, the magnet 302 has a vertical magnetization direction (e.g., the magnetization direction is parallel to the winding axes 306a, 306b of the first and second coils 304a, 304b, as well as parallel to the optical axis of the mechanical iris assembly). When current is run through one of the first and second coils 304a, 304b, a Lorentz force may be generated between that coil and the magnet 302. This Lorentz force may be perpendicular to the winding axis of the coil (and the optical axis of the mechanical iris assembly), which may promote rotation of a rotor plate as described herein.

During operation of the voice coil actuator 300, a controller may be configured concurrently drive current through the first and second coils 304a, 304b in opposite directions. For example, as shown in FIG. 3B, current may be driven (e.g., as controlled by a controller as described herein) through the first coil 310a in a counterclockwise direction (e.g., relative to first winding axis 306a, as represented by arrow 310a). At the same time, current may be driven through the second coil 310b in a clockwise direction (e.g., relative to the second winding axis 306b, as represented by arrow 310b). Driving current through the first and second coils 304a-304b in opposite directions may promote rotation of a rotor plate in a given direction over a wider stroke range than if the voice coil actuator 300 utilized a single coil. Similarly, to promote rotation of the rotor plate in an opposite direction, the current directions in the first and second coils 304a, 304b may be flipped such that current is driven through the first coil 304a in a clockwise direction concurrently with current be driven through the second coil 304b in a counterclockwise direction.

In some variations, the magnet 302 may also be used to provide magnetic preloading between various components of a magnetic iris assembly. For example, in the variation of the mechanical iris assembly 202 shown in FIGS. 2A-2C, the mechanical iris assembly 202 includes a set of ball bearings 260a-260b. The mechanical iris assembly 202 may be configured such that the ball bearings 260a-260b are positioned between the rotor plate 214 and a portion of the housing 208 (e.g., the rear housing element 232). In this way, the rotor plate 214 is configured to move on the ball bearings 260a-260b to facilitate rotation of the rotor plate 214 within the housing 208. Magnetic preloading may be used to promote and maintain contact between the ball bearings 260a-260b and the rotor plate 214, as well as between the ball bearings 260a-260b and the housing 208.

To provide a preloading force, the voice coil actuator 300 may include a preloading plate 308 formed from a ferritic material (e.g., steel) and positioned within the magnetic field of the magnet 302. The preloading plate 308 may be attached to or otherwise incorporated into a portion of the housing 308 (e.g., the preloading plate 308 may be connected to rear housing element 232 of the mechanical iris assembly 202 of FIGS. 2A-2C, the rear housing element 232 may be at least partially formed from a ferritic material to form the preloading plate 308, or the like), such that the magnet 302 is attracted to the preloading plate 308. This magnetic force provides a preloading force to bias the rotor plate 214 and the housing 208 into contact with the set of ball bearings 260a-260b.

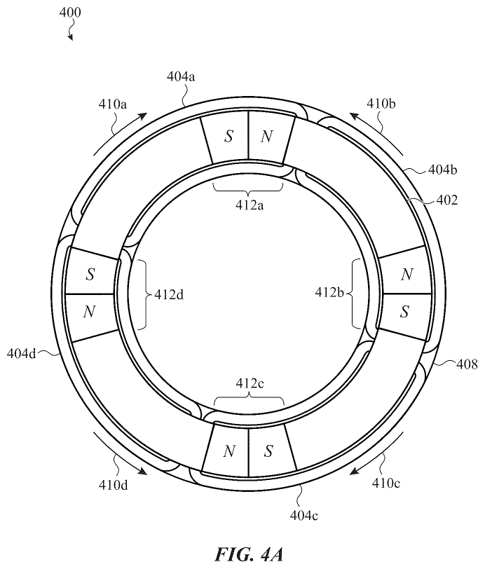

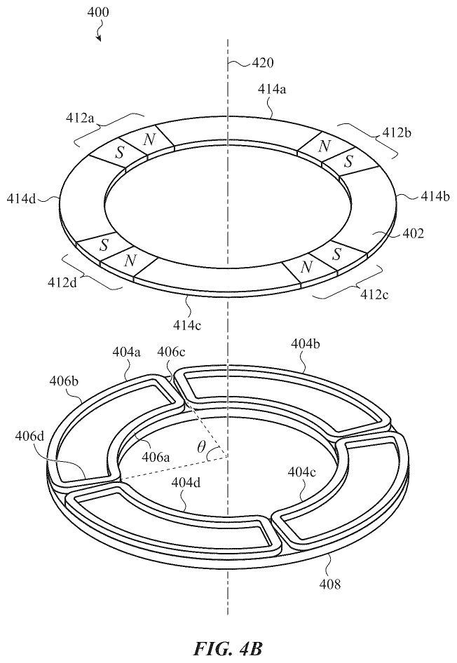

In some variations, a voice coil actuator may include one or more coils having an arcuate shape. FIGS. 4A and 4B show top and exploded perspective views, respectively, of a voice coil actuator 400 that may be used with the mechanical iris assemblies described herein (e.g., in place of the voice coil actuators 220a, 220b of FIGS. 2A-2C) As shown there, the voice coil actuator 400 includes a magnet 402 and a set of coils 404a-404d, each of which has an arcuate shape. Specifically, each coil of the set of coils 404a-404d has a shape that includes a curved inner side 406a and a curved outer side 406b (these components are only labeled for a first coil 404a). Each coil of the set of coils 404a-404d further includes a first connecting side 406c that connects the curved inner side 406a to the curved outer side 406b, and a second connecting side 406d that connects the curved inner side 406a to the curved outer side 406b. Accordingly, current driven a coil (e.g., the first coil 404a) will flow sequentially through its curved inner side 406a, its first connecting side 406c, its curved outer side 406b, and its second connecting side 406d (or vice versa, depending on the direction of the current flow).

The curved inner side 406a and the curved outer side 406b of each coil of the set of coils 404a-404d may curve in a common direction (e.g., toward an optical axis 420 of a mechanical iris assembly that incorporates the voice coil actuator 400). In this way, the set of coils 404a-404d may curve around the optical axis 420. When the voice coil actuator 400 is incorporated into a mechanical iris assembly of an optical assembly as described herein, the set of coils 404a-404d may be positioned to curve around, and thereby at least partially encircle, a portion of a lens module that is positioned inside of the mechanical iris assembly.

In some variations, the curved inner side 406a and the curved outer side 406d of each coil may be parallel (e.g., form a set of parallel curves). For example, the curved inner side 406a and the curved outer side 406b of each coil may each semi-circular (e.g., each have a constant corresponding radius of curvature). In some of these instances, the curved inner side 406a and the curved outer side 406b of each coil may have a common center of curvature (e.g., the curved inner side 406a and the curved outer side 406b are formed from corresponding segments of concentric circles). In this way, each coil of the set of coils 404a-404d may have a corresponding shape that defines an annular segment (e.g., a partial annulus).

The set of coils 404a-404d may be laterally spaced in a side-by-side manner (e.g., in a common plane) that allows the set of coils 404a-404d to at least partially encircle the optical axis 420. Indeed, in variations where each coil of the set of coils 404a-404d has a shape that defines an annular segment, the set of coils 404a-404d may be arranged around a common point, which may be positioned along the optical axis 420. In other words, the set of coils 404a-404d share a common center of curvature (e.g., the center of curvature for the curved sides of a first coil has the same position as the center of curvature for the curved sides of a second coil). In these variations, the set of coils 404a-404d may collectively approximate an annular shape. For example, in some variations, the set of coils 404a-404d collectively forms at least 80% of an annulus.

Specifically, the curved sides (e.g., the curved inner side 406a and the curved outer side 406b) of each coil of the set of coils 404a-404d may subtend a corresponding angle θ (labeled only for the first coil 404a for the purpose of illustrate). The set of coils 404a-404d collectively subtend an overall angle that equals the sum of the angles θ of the individual coils. For example, in the variation shown in FIGS. 4A and 4B, each coil of the set of coils 404a-404d subtends a correspond angle θ of at least 80 degrees. Collectively, the curved inner sides 406a of the set of coils 404a-404d subtend an overall angle of least 320 degrees.

While the set of coils 404a-404d is shown in FIGS. 4A and 4B as having four coils (the first coil 404a, a second coil 404b, a third coil 404c, and a fourth coil 404d) with arcuate shapes, it should be appreciated that the set of coils 404a-404d may include more or fewer coils as may be desired. For example, in other variations the set of coils may include two, three, or five or more coils. Additionally, while each of the set of coils 404a-404d are shown in FIGS. 4A and 4B as having the same size, different coils of the set of coils 404a-404d may have different sizes (e.g., may include curved surfaces that may subtend different angles). As a non-limiting example, a first group of coils of the set of coils 404a-404d may each subtend a first angle (e.g., 30 degrees) while a second group of coils of the set of coils 404a-40d may each subtend a second angle (e.g., 60 degrees) different than the first angle. Collectively, the set of coils 404a-404d may subtend any overall angle as may be desired (e.g., at least 180 degrees, at least 240 degrees, at least 340 degrees, or the like).

As mentioned previously, the voice coil actuator 400 includes at least one magnet. In the variation shown in FIGS. 4A and 4B, the voice coil actuator 400 includes a magnet 402 that has an annular shape and includes a plurality of magnetic regions 412a-412d. Forming a magnet 402 in this manner may allow for precise positioning of the plurality of magnet regions 412a-412d relative to each other and relative to the set of coils 404a-404d. It should be appreciated that, in other variations, the voice coil actuator 400 may alternatively include a plurality of individual magnets in which each of the plurality of magnetic regions 412a-412d is formed as a separate individual magnet.

When the magnet 402 has an annular shape, the magnet 402 may be positioned within the mechanical iris assembly to encircle the optical axis 420. Additionally, when a lens module of an optical assembly is positioned at least partially inside of the mechanical iris assembly, the magnet 402 may be positioned to at least partially encircle a portion of the lens module. While the magnet 402 is shown in FIGS. 4A and 4B as forming a complete annulus, it should be appreciated that in other variations the magnet 402 may form an incomplete/partial annulus, such as an annular segment that subtends an angle less than 360 degrees (e.g., at least 180 degrees, at least 240 degrees, at least 340 degrees, or the like).

In some instances, the magnet 402 has at least as many magnetic regions 412a-412d as the number of coils of the set of coils 404a-404d. For example, the magnet 402 in FIGS. 4A and 4B have the same number of magnetic regions 412a-412d (e.g., four) as the number of coils in the set of coils 404a-404d. The magnetic regions 412a-412d may be spaced such that, for at least one relative position between the magnet 402 and the set of coils 404a-404d, each magnetic region 412a-412d is positioned over a different corresponding coil of the set of coils 404a-404d. For example, when the magnetic 402 and set of coils 404a-404d are positioned as shown in FIGS. 4A and 4B, a first magnetic region 412a is positioned over the first coil 404a, a second magnetic region 412b is positioned over the second coil 404b, a third magnetic region 412c is positioned over the third coil 404c, and a fourth magnetic region 412d may be positioned over the fourth coil 404d.

Accordingly, during operation of the voice coil actuator 400, each coil of the set of coils 404a-404d may be positioned within the magnetic field of at least one corresponding magnetic region of the magnet 402. It should be appreciated that, however, that depending on the relative positioning between the set of coils 404a-40d and the magnet 402 (e.g., as a rotor plate incorporating the magnet 402 rotates), a given coil of the set of coils 404a-404d may be simultaneously positioned in the magnetic fields of multiple magnetic regions. For example, the voice coil actuator 400 may be configured such that, at some point in the rotation of the magnet 402 relative to the set of coils 404a-404d, the first coil 404a is simultaneously positioned in the magnetic fields of both the first magnetic section 414a and the fourth magnetic section 414d.

Each of the plurality of magnetic regions 412a-412d has a corresponding magnetization direction. In some variations, the corresponding magnetization directions of the magnetic regions 412a-412d are positioned in a common plane. In the variation shown in FIGS. 4A and 4B, each of the magnetic regions 412a-412d has a corresponding horizontal magnetization direction (e.g., a magnetization direction perpendicular to the optical axis 420), such that the plurality of magnetic regions 412a-412d has a corresponding plurality of magnetizations that are co-planar.

The plurality of magnetic regions 412a-412d may be configured such that immediately adjacent pairs of magnetic regions 412a-412d (e.g., with no intervening magnetic regions along the annular shape of the magnet 402) have opposite polarities. For example, the first magnetic region 412a of magnet 402 is immediately adjacent to both the second magnetic region 412b and the fourth magnetic region 412d. The first magnetic region 412a has an opposite polarity of the second magnetic regions 412b, such that the north pole of the first magnetic region 412a faces the north pole of the second magnetic region 412b along the annular shape of the magnet 402. The first magnetic region 412a also has an opposite polarity of the fourth magnetic region 412d, such that the south pole of the first magnetic region 412a faces the south pole of the fourth magnetic region 412d along the annular shape of the magnet 402. Similarly, the third magnetic region 412c of magnet 402 is also immediately adjacent to both the second magnetic region 412b and the fourth magnetic region 412d. The third magnetic region 412c has an opposite polarity of the second magnetic regions 412b, such that the south pole of the third magnetic region 412c faces the south pole of the second magnetic region 412b. The third magnetic region 412c also has an opposite polarity of the fourth magnetic region 412d, such that the north pole of third magnetic region 412c faces the north pole of the fourth magnetic region 412d.

During operation of the voice coil actuator 400, a controller may drive through one or more of the set of coils 404a-404d, such that each coil carrying current generates a corresponding Lorentz force with one or more of the magnetic regions 412a-412d of the magnet 402. In some variations, the voice coil actuator 400 may be operated such that current is driven through immediately adjacent coils (e.g., with no intervening coils) of the set of coils 404a-404d in opposite directions. For example, as shown in FIG. 4A, current may be driven (e.g., as controlled by a controller as described herein) through the first coil 404a in a clockwise direction (as represented by arrow 410a). At the same time, current may be driven through the second coil 404b (which is immediately adjacent to the first coil 404a) in a counterclockwise direction (as represented by arrow 410b). Similarly, current may be simultaneously driven through the fourth coil 404d (which is also immediately adjacent to the first coil 404a) in a counterclockwise direction (as represented by arrow 410d). Additionally, current may be simultaneously driven through the third coil 404c (which is also immediately adjacent to both the second coil 404b and the fourth coil 404d) in a clockwise direction (as represented by arrow 410c).

Collectively, the set of coils 404a-404d will generate a set of Lorentz forces that promote rotation of the magnet 402 (as well as a rotor plate incorporating the magnet 402) in a first direction. To rotate the magnet 402 in a second direction opposite the first direction, the direction of the current may be reversed, such that current is driven through the first and third coils 404a, 404c in a counterclockwise direction, and current is driven through the second and fourth coils 404b, 404d in a clockwise direction. In still other instances, current may be driven through all of the coils 404a-404d in a common direction (e.g., each of the first through fourth coils 404a-404d receive current in a clockwise direction), which may be used to hold the magnet 402 in a particular position relative to the set of coils 404a-404d.

Also shown in FIGS. 4A-4B is a preloading plate 408, which may facilitate magnetic preloading as discussed herein. For example, in variations where the voice coil actuator 400 is incorporated into the mechanical iris assembly 202 of FIGS. 2A-2C, the preloading plate 408 may be incorporated into or otherwise attached to a portion of housing 208 and may be positioned in the magnetic field(s) of one or more of the magnetic regions 412a-412d of the magnet 402. In some instances, the preloading plate 408 may have an annular shape (e.g., a complete annulus or partial annulus as discussed herein). Additionally, the set of ball bearings 260a-260b may have any suitable positioning relative to the set of coils 404a-404d. For example, one or more ball bearings of the set of ball bearings 260a-260b may be positioned between immediately adjacent coils of the set of coils 404a-404d (e.g., between the first coil 404a and the second coil 404b). Additionally or alternatively, one or more ball bearings of the set of ball bearings may be positioned to extend through a coil of the set of coils 404a-404d (e.g., a ball bearing may be positioned between the curved inner side 406a and the curved outer side 406b of the first coil 404a to extend through the first coil 404a).

In the variation shown in FIGS. 4A and 4B, immediately adjacent magnetic regions of the plurality of magnetic regions 412a-412d may be separated by non-magnetic regions of the magnet 402 (e.g., portions of the magnet that do not generate a magnetic field). For example, in the variation shown in FIGS. 4A and 4B, a first non-magnetic region 414a separates the first magnetic region 412a from the second magnetic region 412b, a second non-magnetic region 414b separates the second magnetic region 412b from the third magnetic region 412c, a third non-magnetic region 414c separates the third magnetic region 412c from the fourth magnetic region 412d, and a fourth non-magnetic region 414d separates the fourth magnetic region 412d form the first magnetic region 412a.

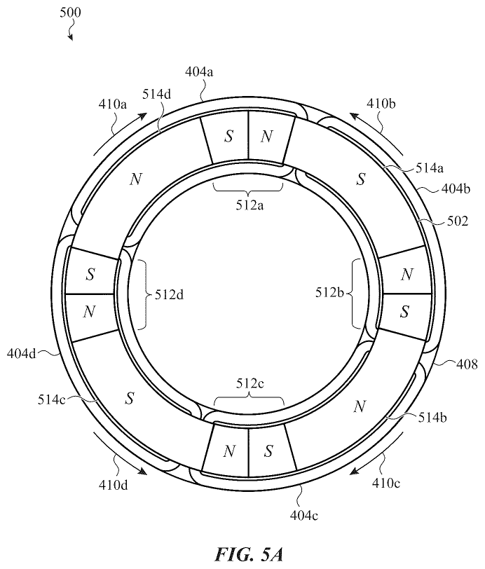

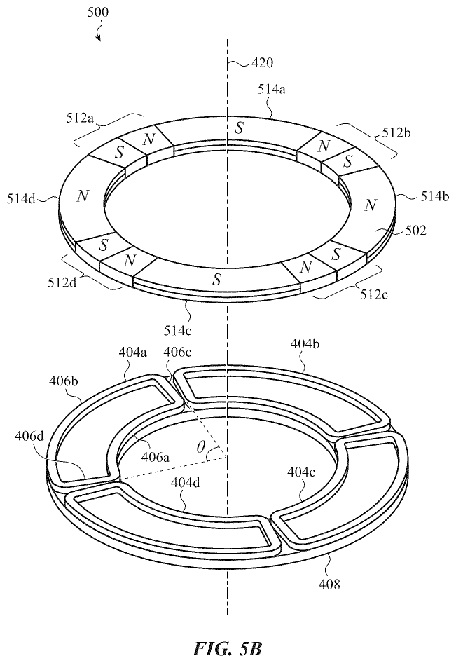

In other variations, the plurality of magnetic regions 412a-412d may be separated by additional magnetic regions having different magnetization directions than the plurality of magnetic regions 412a-412d, which may alter the shape of the magnetic field produced by the magnet 402. For example, FIGS. 5A and 5B show top and exploded perspective views, respectively, of a voice coil actuator 500 that may be used with the mechanical iris assemblies described herein. The voice coil actuator 500 may be configured and operated the same as the voice coil actuator 400 of FIGS. 4A and 4B, except that the magnet 402 of voice coil actuator 400 has been replaced with magnet 502. In this instance, the magnet 502 includes a first plurality of magnetic regions 512a-512d and a second plurality of magnetic regions 514a-514d. Each of the first plurality of magnetic regions 512a-512d has a corresponding magnetization direction that is positioned in a common plane (e.g., the magnetic regions 512a-512d may each have a corresponding horizontal magnetization direction that is perpendicular to the optical axis 420). Each of the second plurality of magnetic regions 514a-514d has a corresponding magnetization direction that is perpendicular to the common plane (e.g., the magnetic regions 514a-514d may each have a corresponding vertical magnetization direction that is parallel to the optical axis 420).

In some instances, the first plurality of magnetic regions 512a-512d may alternate polarity, such that immediately adjacent members of the first plurality of magnetic regions 512a-512d (e.g., with no intervening magnetic regions having a horizontal magnetization direction) have opposite polarities. For example, the first plurality of magnetic regions 512a-512d may include a first magnetic region 512a, a second magnetic region 512b, a third magnetic region 512c, and a fourth magnetic region 512d. The first magnetic region 512a and the second magnetic region 512b are considered to be immediately adjacent members of the first plurality of magnetic regions 512a-512d, even though they are separated by a magnetic region 514a of the second plurality of magnetic regions 514a-514d that has a vertical magnetization direction. The first magnetic region 512a has an opposite polarity of the second magnetic regions 512b, such that the north pole of the first magnetic region 512a faces the north pole of the second magnetic region 512b. The second magnetic region 512b has an opposite polarity as the third magnetic region 512c, and so on.

Similarly, the second plurality of magnetic regions 514a-514d may alternate polarity, such that immediately adjacent members of the second plurality of magnetic regions 514a-514d (e.g., with no intervening magnetic regions having a vertical magnetization direction) have opposite polarities. For example, the second plurality of magnetic regions may include a fifth magnetic region 514a, a sixth magnetic region 514b, a seventh magnetic region 514c, and an eight magnetic region 514d. The fifth magnetic region 514a has an opposite polarity of the sixth magnetic region 514b (which is considered to be an immediately adjacent member of the second plurality of magnetic regions 514a-514d), such that a north pole of the fifth magnetic region 514a faces an opposite direction as the north pole of the sixth magnetic region 514b, and so on. Collectively, the alternating polarities of both the first and second pluralities of magnetic regions 512a-512d, 514a-514d may create a Halbach array that amplifies the magnetic field on one side of the magnet 504 while reducing the strength of the magnetic field on an opposite side of the magnet 504. Accordingly, the magnet 504 may be positioned to direct the amplified portion of the magnetic field toward the set of coils 404a-40d, which may improve the efficiency of the voice coil actuator 500.

It should be appreciated that the coils of the voice coil actuators described herein (e.g., the sets of coils of the voice coil actuators 400, 500 of FIGS. 4A-5B) may be formed in any suitable manner. In some variations, a given coil may be formed using a wound coil forming process in which a wire formed from a conductive material (e.g., copper) is wound around a temporary or permanent holding structure to form the coil. In other variations, a given coil may be formed using an additive processing technique, such as those described in U.S. Pat. No. 10,638,031 B1, filed on Mar. 29, 2018, and titled “Additive coil structure for voice coil motor actuator,” the contents of which are hereby incorporated by reference in their entirety. Using an additive processing technique may provide additional flexibility in the design of the set of coils of a voice coil actuator. Additionally, the coils may be formed as part of a printed circuit (e.g., a flexible printed circuit or a rigid printed circuit) of the mechanical iris assembly, which may allow for space savings and/or reduced manufacturing complexity.

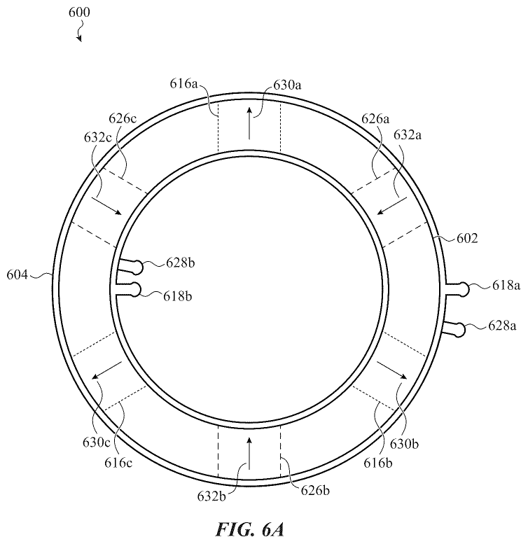

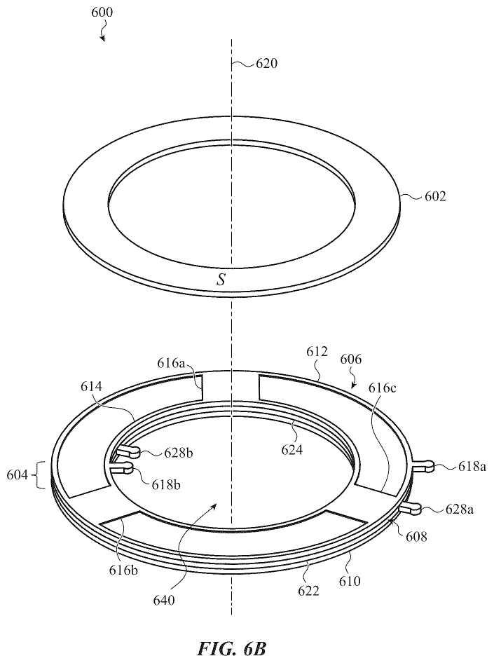

FIGS. 6A and 6B show top and exploded perspective views, respectively, of a voice coil actuator 600 that may be used with the mechanical iris assemblies described herein. The voice coil actuator 600 includes at least one magnet 602, and at least one printed circuit 604 that defines at least one coil. In these instances, each coil may be formed from one or more conductive layer of the printed circuit 604. In the variation shown in FIGS. 6A and 6B, the voice coil actuator 600 includes a single printed circuit 604 that includes a first coil 606 and a second coil 608. It should be appreciated however, other variations of the voice coil actuator 600 may include a single coil (e.g., only the first coil 606), or may include three or more coils. In instances where the voice coil actuator 600 includes multiple coils, these coils may be formed as part of a single printed circuit (e.g., the printed circuit 604) or may be formed as part of multiple printed circuits (e.g., the first coil 606 may be formed as part of a first printed circuit and the second coil 608 may be formed as part of a second printed circuit). Multiple coils may be electrically isolated from each other using an insulating material (e.g., polyimide) that forms part of the printed circuit 604. Additionally, it should be appreciated that the at least one printed circuit 604 may include additional electrical traces that facilitate other functions of the cameras described herein, but that may be electrically isolated form the at least one coil by the insulating material of the printed circuit.

The first coil 606 may include an outer trace 612, and inner trace 614, and a set of connecting traces 616a-616c that electrically connect the outer trace 612 to the inner trace 614 in parallel. The printed circuit 604 may include define a central opening 640 (e.g., to accommodate light passing through the mechanical iris assembly), and the inner trace 614 and outer trace 612 each at least partially encircle the central opening 640. For example, the inner trace 614 may follow an inner perimeter of the printed circuit 604, and may thereby border the central opening 640. The outer trace 612 may follow an outer perimeter of the printed circuit 604, such that the inner trace 614 is positioned between the outer trace 612 and the central opening 640.

To drive current through the first coil 606, a controller may apply a voltage potential across the inner trace 614 and the outer trace 612 (e.g., via a first terminal 618a electrically connected to the outer trace 612 and a second terminal 618b electrically connected to the inner trace 614), which electrically connects the set of connecting traces 616a-616c in parallel. Accordingly, current may flow between the outer trace 612 and the inner trace 614 through the set of connecting traces 616a-616c (as illustrated by arrows 630a-630c). The set of connecting traces 616a-616c may each be radially oriented relative to an optical axis 620 of a mechanical iris assembly that incorporates the voice coil actuator 600, such that each connecting trace extends radially away from the optical axis 620 from the inner trace 614 to the outer trace 612. In this way, current may flow through each of the connecting traces 616a-616c in a corresponding radial direction, and thus may flow radially toward the optical axis 620 or radially away from the optical axis 620 depending on the potential applied across the inner trace 614 and the outer trace 612. While shown in FIGS. 6A and 6B as having three connecting traces, it should be appreciated that the set of connecting traces 616a-616c may have more (e.g., four or more) or fewer (e.g., two) connecting traces as may be desired.

When the voice coil actuator 600 is incorporated into a mechanical iris assembly as described herein, the first coil 606 is positioned in the magnetic field generated by the at least one magnet 602. In the variation shown in FIGS. 6A and 6B, the at least one magnet 602 includes a single magnet having an annular shape and a vertical magnetization direction (e.g., the magnetization direction is parallel to the optical axis). In these instances, the magnetization direction of the magnet 602 is perpendicular to the direction(s) of current flow through the set of connecting traces 616a-616c). As current flows through between the inner trace 614 and the outer trace 612 through the set of connecting traces 612a-616c, a Lorentz force may be generated between the first coil 606 and the magnet 602 that promotes relative rotation between the magnet 602 and the first coil 606 around the optical axis 620. It should be appreciated that in other instances the magnet 602 may be replaced by multiple magnets (e.g., each having a corresponding vertical magnetization direction and/or a shape that defines an annular segment). The direction of current flow may be flipped to promote rotation in an opposite direction.

In examples where the voice coil actuator 600 includes a second coil 608, the second coil 608 may include an outer trace 622, and inner trace 624, and a set of connecting traces 626a-626c that electrically connect the outer trace 622 to the inner trace 624 in parallel. The second coil 608 may be configured in any manner as described herein with respect to the first coil 606, though it should be appreciated that the first coil 606 may be configured differently than the second coil 608. For example, while the first and second coils 606, 608 are shown in FIG. 6A as each having the same number of connecting traces (e.g., three), it should be appreciated that the first coil 606 may have a different number of connecting traces 616a-616c than the number of connecting traces 626a-626c of the second coil 608. The set of connecting traces 626a-626c of the second coil 608 may each be radially oriented relative to the optical axis 620 such that current may flow radially (e.g., radially away from the optical axis 620 or radially toward the optical axis 620) through the set of connecting traces 626a-626c.

When the voice coil actuator 600 is incorporated into a mechanical iris assembly as described herein, the second coil 608 is also positioned in the magnetic field generated by the at least one magnet 602. For example, the first coil 606 and the second coil 608 may be concentrically arranged, with the first coil 606 positioned closer to the magnet 602 (e.g., between the second coil 608 and the magnet 602) along the optical axis 620, thereby positioning the first coil 606 and the second coil 608 in the magnetic field of the at least one magnet 602. Current may be driven the second coil 608, such as by a controller as described herein applying a voltage across a first terminal 628a and a second terminal 628b, to generate a Lorentz force between the second coil 608 and the at least one magnet 602. The controller may be configured to selectively drive current through the first coil 606 and the second coil 608. In these instances, the controller may drive current through only one coil at a time (e.g., only the first coil 606 or only the second coil 608), or may drive current concurrently through both the first coil 606 and the second coil 608.

For example, in some instances the controller may be configured to concurrently drive current through the first coil 606 and the second coil 608 in a common radial direction during a first period of time. During this period of time, current will flow through the set of connecting traces 616a-616c of the first coil 606 in a first radial direction (e.g., radially inward), and will also flow through the set of connecting traces 626a-626c of the second coil 608 in the same radial direction (e.g., radially inward). In these instances, the first coil 606 and the second coil 608 will generate corresponding Lorentz forces in a common direction, and thereby providing a larger rotational force than either coil individually. This may find particular utility in instances where a controller includes a voice coil driver having multiple outputs, each of which has a limited corresponding output power. In this way, the first and second coils 606, 608 may be connected to and be driven by different outputs, which may thereby increase the overall power received by the first and second coils 606, 608.

During a different period of time, the controller may be configured to concurrently drive current through the first coil 606 and the second coil 608 in opposite radial directions. During this period of time, will flow through the set of connecting traces 616a-616c of the first coil 606 in a first radial direction (e.g., radially inward, as indicated by arrows 630a-630c in FIG. 6A), and will also flow through the set of connecting traces 626a-626c of the second coil 608 in an opposite radial direction (e.g., radially outward, as indicated by arrows 632a-632c in FIG. 6A). In these instances, the first coil 606 and the second coil 608 will generate corresponding Lorentz forces in opposite directions, which may be used to stop relative rotation between the first and second coils 606, 608 and the magnet 602.

For example, the controller may drive current through the first coil 606 (or concurrently through the first coil 606 and the second coil 608 in a common radial direction) to cause relative rotation between the first and second coils 606, 608 and the magnet 602. This may cause rotation of a rotor plate of the mechanical iris assemblies described herein, which may reposition a set of elements. The controller may subsequently drive current concurrently through the first coil 606 and the second coil 608 in opposite radial directions. Depending on the relative amount of current driven through the first and second coils 606, 608, this may slow, stop, or reverse the rotation of the rotor plate. In this way, the second coil 608 may act as a brake to stop rotation of the rotor plate.

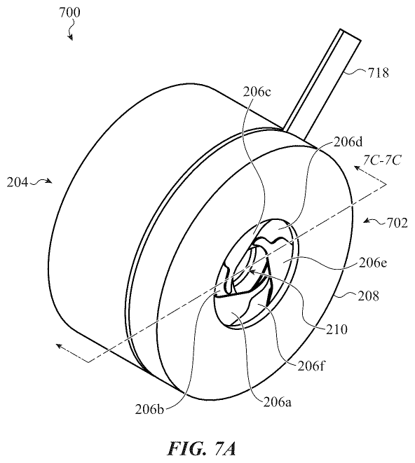

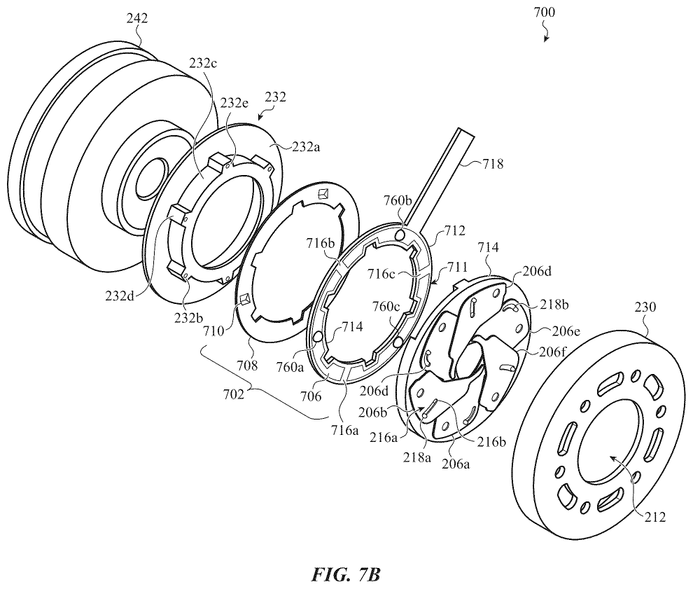

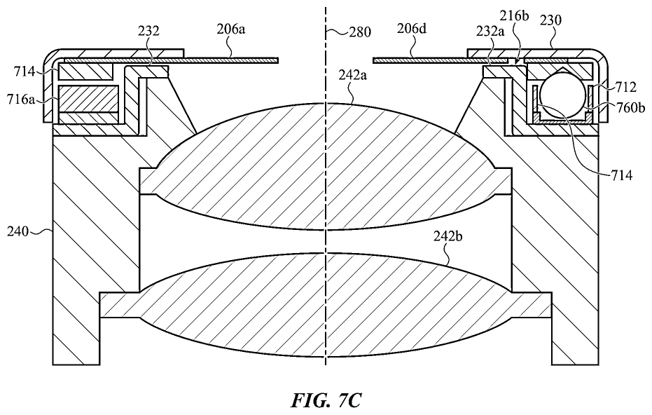

FIGS. 7A-7C show perspective, exploded, and cross-sectional side views (taken along line 7C-7C), respectively, of a variation of an optical assembly 700 that includes a variation of a mechanical iris assembly 702 as described herein. The optical assembly 700 and the mechanical iris assembly 702 may be configured the same as the optical assembly 200 and the mechanical iris assembly 202 (with like components labeled the same), except that the mechanical iris assembly 702 includes an actuator assembly that includes at least one magnet (depicted in FIGS. 7A-7C as a magnetized rotor plate 714) and a printed circuit 706 that includes at least one coil (such as those described above with respect to FIGS. 6A and 6B).

In the variation shown in FIGS. 7A-7C, a portion of the rotor plate 714 may be formed from a magnetized material, such that the rotor plate 714 generates a magnetic field. In this way, the rotor plate 714 may act as the at least magnet of the actuator assembly. In other variations, it should be appreciated that one or more magnets (e.g., the magnet 602 from FIGS. 6A-6B) may be formed separately from and attached to the rotor plate 714. The mechanical iris assembly 702 is configured to position the printed circuit 706 in the magnetic field of the at least one magnet (e.g., the magnetic field of the magnetized rotor plate 714), such that the current may be driven through the at least one coil of the printed circuit 706 to generate one or more Lorentz forces between the at least one coil and the at least one magnet.

The printed circuit 706, and thereby the at least one coil, is fixed relative to the housing 208, such that the Lorentz forces generated between the at least one coil and the at least one magnet may controllably rotate the rotor plate 714 relative to the housing. In some variations, the printed circuit 706 may be directly connected to the housing 208. In the variation shown in FIGS. 7A-7C, the mechanical iris assembly 702 includes a preloading plate 708 that is positioned between the printed circuit 706 and the first portion 232a of the rear housing element 232. The printed circuit 706 may be attached to the preloading plate 708, which in turn may be connected to the rear housing element 232. Additionally or alternatively, in some variations one or more protrusions (e.g., the first protrusion 232d and/or the second protrusion 232c) extending from the sidewall 232c of the rear housing element 232 may extend into corresponding recesses in the preloading plate 708 and/or the printed circuit 706, which may act to prevent relative rotation between these components and the rear housing element 232.

Each coil of the printed circuit 706 may be configured in any manner as described above with respect to FIGS. 6A-6B. For example, the printed circuit 706 is shown in FIGS. 7A-7C as having a coil 711 having an outer trace 712, an inner trace 714, and a plurality of connecting traces 716a-716c electrically connecting the inner trace 714 to the outer trace 712. The printed circuit 706 may, in some instances, include one or more tab portions (e.g., tab portion 718) that extends from the mechanical iris assembly 702. The tab portion(s) may provide electrical connections to the inner trace 714 and the outer trace 712, to allow for a potential to be placed across the inner trace 714 and the outer trace 712. Accordingly, the tab portion 718 may facilitate an electrical connection between the printed circuit 706 and a controller (not shown) that controls the mechanical iris assembly 702. Current may be driven in parallel through the connecting traces 716a-716c, to generate a Lorentz force that rotates the rotor plate 714 relative to the housing 208. This rotation may change the relative positioning of the set of blade elements 206a-206f, such as described in more detail.

The preloading plate 708 may be positioned in the magnetic field of the at least one magnet to provide magnetic preloading such as described herein. For example, the mechanical iris assembly may include a set of ball bearings 760a-760c that is positioned between the preloading plate and the rotor plate 714. Each ball bearing of the set of ball bearings 760a-760c may be held in contact, by virtue of the preloading force between the preloading plate 708 and the at least one magnet, between the preloading plate 708 and the rotor plate 714. Specifically, the preloading plate 708 and the rotor plate 714 may each include one or more tracks (e.g., track) to maintain the position of the set of ball bearings 760a-760c in the mechanical iris assembly 702. To allow for contact between the ball bearings 760a-760c and both the preloading plate 708 and the rotor plate 714, the printed circuit 706 may define one or more openings extending therethrough. The each ball bearing may extend through a corresponding opening in the printed circuit 706, such that the ball bearing extends through the printed circuit 706. This may position each ball bearing between the inner trace 714 and the outer trace 712 of the coil 711.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

What is claimed is:

1. A camera comprising:
an optical assembly having an optical axis and comprising:
a lens module; and
a mechanical iris assembly comprising:
a housing;
a set of blade elements;
a rotor plate; and
an actuator assembly comprising a magnet that is fixed relative to the rotor plate, a first coil, and a second coil; and
a controller, wherein:
the first coil and the second coil are positioned in a magnetic field of the magnet;
the controller is configured to concurrently drive current through the first coil and the second coil in opposite directions to rotate the rotor plate relative to the housing;
the mechanical iris assembly is configured such that rotation of the rotor plate relative to the housing rotates the set of blade elements relative to the housing.

2. The camera of claim 1, wherein:
the mechanical iris assembly comprises a set of ball bearings and a preloading plate formed from a ferritic material.

3. The camera of claim 1, wherein:
the housing comprises a front housing element and a rear housing element;
the rear housing element comprises a sidewall that defines a cavity; and
the lens barrel extends at least partially into the cavity.

4. The camera of claim 3, wherein:
the rotor plate circumferentially surrounds the sidewall.

5. The camera of claim 1, wherein:
the magnet has a magnetization direction that is parallel to the optical axis.

6. A camera comprising:
an optical assembly having an optical axis and comprising:
a lens module; and
a mechanical iris assembly comprising:
a housing;
a set of blade elements;
a rotor plate; and
an actuator assembly comprising:
at least one magnet; and
a set of coils, each having an arcuate shape, wherein:
the actuator assembly is configured to rotate the rotor plate relative to the housing; and
the mechanical iris assembly is configured such that rotation of the rotor plate relative to the housing rotates the set of blade elements relative to the housing.

7. The camera of claim 6, wherein:
each coil of the set of coils has a shape that includes a curved inner side and a curved outer side that curve in a common direction.

8. The camera of claim 7, wherein:
the curved inner side and the curved outer side of each coil of the set of coils are parallel.

9. The camera of claim 7, wherein:
the shape of each coil of the set of coils forms an annular segment.

10. The camera of claim 9, wherein:
the set of coils are arranged around the optical axis.

11. The camera of claim 10, wherein:
set of coils collectively subtend an angle of least 180 degrees.

12. The camera of claim 6, wherein:
the at least one magnet comprises a magnet having an annular shape.

13. The camera of claim 12, wherein:
the magnet comprises a first plurality of magnetic regions, each having a corresponding magnetization direction that is perpendicular to the optical axis.

14. The camera of claim 13, wherein:
the comprises a second plurality of magnetic regions, each having a corresponding magnetization direction that is parallel to the optical axis.

15. A mechanical iris assembly comprising:
a housing;
a set of blade elements;
a rotor plate;
a printed circuit defining at least one coil; and
an actuator assembly comprising:
at least one magnet; and
the at least one coil, wherein:
the actuator assembly is configured to rotate the rotor plate relative to the housing; and
the mechanical iris assembly is configured such that rotation of the rotor plate relative to the housing rotates the set of blade elements relative to the housing.

16. The mechanical iris assembly of claim 15, wherein:
the at least one coil comprises a first coil; and
the first coil comprises an inner trace, an outer trace, and a set of connecting traces that electrically connect the inner trace to the outer trace in parallel.

17. The mechanical iris assembly of claim 16, wherein:
the at least one coil comprises a second coil; and
the second coil comprises an inner trace, an outer trace, and a set of connecting traces that electrically connect the inner trace of the second coil to the outer trace of the second coil in parallel.

18. The mechanical iris assembly of claim 17, comprising:
a controller, wherein the controller is configured to selectively drive current through the first coil and the second coil.

19. The mechanical iris assembly of claim 18, wherein:
the controller is configured, during a period of time, to concurrently drive current through the first and second coils such that:
current flows through the set of connecting traces of the first coil in a first radial direction; and
current flows through the set of connecting traces of the second coil in a second radial direction opposite the first radial direction.

20. The mechanical iris assembly of claim 15, comprising:
a set of ball bearings, wherein the set of ball bearings are positioned to extend through one or more openings defined through the printed circuit.
